(19) United States
(12) Patent Application Publication
(10) Pub. No.: US 2016/0083116 A1
(43) Pub. Date: Mar. 24, 2016

(54) SUPPLY PLATFORM THAT MOVES ALONG

(71) Applicant: HUBTEX MASCHINENBAU GMBH & CO. KG, Fulda (DE)

(72) Inventor: JUERGEN KELLER, GROSSENLUEDER (DE)

(21) Appl. No.: 14/890,588

(22) PCT Filed: May 6, 2014
(86) PCT No.: PCT/EP2014/059173

§ 371 Date: Nov. 12, 2015

(30) Foreign Application Priority Data
May 14, 2013 (DE) 20 2013 102 095.8

(51) Int. Cl. B64F 5/00; B66F 9/075; B66F 9/24; B66F 9/06

(52) U.S. Cl. CPC B64F 5/0036; B66F 9/063; B66F 9/07572; B66F 9/24

(57) ABSTRACT

An accompanying supply platform for a very slowly moving mounting unit of a large good includes an overall drive system, and a device configured to automatically follow the mounting unit so as to avoid contact therewith.

### CROSS REFERENCE TO PRIOR APPLICATIONS

This application is a U.S. National Phase application under 35 U.S.C. §371 of International Application No. PCT/EP2014/059173, filed on May 6, 2014 and which claims benefit to German Patent Application No. 20 2013 102 095.8, filed on May 14, 2013. The International Application was published in German on Nov. 20, 2014 as WO 2014/184045 A1 under PCT Article 21(2).

### FIELD

The present invention relates to a moving supply platform, which is also referred to as an accompanying supply platform, for a very slowly moving mounting unit for large goods.

### BACKGROUND

Large goods, in particular aircrafts, are moved very slowly during their assembly to achieve a similar effect as is the case for smaller goods and for assembly line production. For this purpose, the large goods are accompanied by a mounting unit moving at the same speed as the large good. This mounting unit can temporarily be attached to the large good.

### SUMMARY

An aspect of the present invention is to provide an accompanying supply platform for a mounting unit.

In an embodiment, the present invention provides an accompanying supply platform for a very slowly moving mounting unit of a large good which includes an overall drive system, and a device configured to automatically follow the mounting unit so as to avoid contact therewith.

### BRIEF DESCRIPTION OF THE DRAWINGS

The present invention is described in greater detail below on the basis of embodiments and of the drawings in which:

FIG. 1 shows a perspective view of a large good to which a mounting unit is attached which follows an accompanying supply platform according to the present invention;

FIG. 2 shows a view from above onto an accompanying supply platform and a part of a mounting unit;

FIG. 3 shows a frontal view of a part of the drive system for the following operation;

FIG. 4 shows a view of a part of the drive system for fast speed driving;

FIG. 5 shows a view from above onto a part of an accompanying supply platform and of a mounting unit;

FIG. 6 shows a lateral view of an accompanying supply platform and a part of a mounting unit;

FIG. 7 shows a detailed view from above onto a part of an accompanying supply platform and of a mounting unit;

FIG. 8 shows an illustration of a display of the accompanying supply platform which facilitates the coarse alignment of the accompanying supply platform with the mounting unit for the user;

FIG. 9 shows the approach of the accompanying supply platform to the mounting unit viewed from above;

FIG. 10 shows the approach of the accompanying supply platform to the mounting unit viewed from above;

FIG. 11 shows the coarse alignment of the accompanying supply platform relative to the mounting unit viewed from above;

FIG. 12 shows the coarse alignment of the accompanying supply platform relative to the mounting unit viewed from above; and

FIG. 13 shows an illustration as in FIGS. 11 and 12, however, after a coarse alignment has been carried out.

### DETAILED DESCRIPTION

The accompanying supply platform for a very slowly moving mounting unit according to the present invention has a drive system, or more accurately, an overall drive system. The accompanying supply platform may therefore also be referred to as a self-propelled accompanying supply platform. The accompanying supply platform has a device for the automatic, contactless following of the mounting unit, for example, with respect to speed and direction.

In lieu of or in addition to mounting the large good, the mounting unit may also serve to assemble the large good. The mounting unit may therefore also be referred to as an assembly and/or equipment unit.

The mounting unit moves very slowly, for example, slower than 1 m per minute, and, for example, approximately 1 mm to 100 mm per minute.

The overall drive system can, for example, also include steering components and, for this reason, may also be referred to as an actuating and steering system.

The large good can, for example, be an aircraft.

Since the supply platform has a device to contactlessly follow the mounting unit, the mounting unit and, thus, the system, which is made up of the large good and the mounting unit, may remain at least largely mechanically unaffected by the accompanying supply platform. It may thus be achieved that the accompanying supply platform does not result at least approximately in any increase of the load of possible fasteners situated between the large good and the mounting unit.

Since the supply platform has a device to automatically follow the mounting unit, a precondition is established in which the driver, who takes over the task of driving, may be expendable during the following operation.

In an embodiment of the present invention, the device can, for example, include monitoring devices which continuously monitor the position of the accompanying supply platform and of the mounting unit to each other.

In an embodiment of the present invention, the monitoring devices can, for example, include distance sensors and, for example, position sensors. Ultrasonic sensors, inductively working sensors, laser sensors, or radar sensor may, for example, be provided as distance sensors. Sensors detecting an absolute position, for example, via the contour, for example, laser sensors, or radar sensors, may be provided as position sensors.

In an embodiment of the present invention, the device for independently and contactlessly following the mounting unit can, for example, include a main computer to which the data of the monitoring devices can, for example, be transmitted. The position of the accompanying supply platform and the mounting unit to each other, which is determined by the monitoring devices, can, for example, be transmitted to the main computer. Based on this information, the main computer can, for example, calculate the necessary correction regarding speed and/or direction of the accompanying supply platform. The main computer can, for example, transmit this information to the drive system.

In an embodiment of the present invention, a shutting-off of the overall system of the accompanying supply platform and, for example, of the entire “assembly line” can, for example, result if one of the values detected by the sensors exceeds the respective value defined as a permitted limit. When one of the values detected by the sensors of the accompanying supply platform exceeds the respective value defined as a permitted limit, the movement of the large good can, for example, be stopped, in particular to prevent collisions.

In an embodiment of the present invention, two differently constructed, separate drive systems can, for example, be provided. The overall drive system can thus, for example, include two differently composed, separate drive systems. The term “separate drive systems” within the context of this publication refers in particular to drive systems which do not have common components, but to drive systems which are constructed completely separately. This takes account of the fact that, for example, two very separate, substantially differing requirements result regarding the speed of the accompanying supply platform. This is because the accompanying supply platform must be able to drive as slowly as the large good. The accompanying supply platform can, for example, drive slower than 1 m per minute, and, for example, drive at a speed of 1 mm to 200 mm per minute. These two drive systems can, for example, be used independently of each other.

In an embodiment of the present invention, the accompanying supply platform can, for example, have at least one drive wheel and can, for example, furthermore have at least two drive wheels.

The two drive systems can, for example, include different drive wheels. One drive system can, for example, include exactly one different drive wheel or different drive wheels than the other drive system.

In order to provide a fast return from the end of the assembly line to the beginning, the accompanying supply platform can, for example, also drive at a standard speed of an industrial vehicle, for example, 16 meters per minute to 166 meters per minute.

The accompanying supply platform can thus, for example, drive at at least two speeds which can, for example, have a ratio of 1:80 to 1:166000 to each other. Such a large speed range or speed difference cannot be covered by the control range of drives or at least not by standard components.

Since these two very different speeds can, for example, be covered by two different, separate drive systems, the overall drive system can, for example, be based on standard components. The two separate drive systems can thus, for example, be based on standard components. The two drive systems can, for example, include a standard single cycle engine or be built on the engine.

In an embodiment of the present invention, a drive system for fast speed driving can, for example, be provided, in particular for the return drive from the end of the assembly line to the beginning over a long distance. This drive system can, for example, include at least one drive unit having a standard drive, which includes a drive band, a standard transmission, an engine, and a brake. In an embodiment, the standard drive can, for example, be made up of these components. The brake can, for example, be an electromagnetic brake.

In an embodiment of the present invention, the drive system for fast speed driving (thus, the fast speed drive system) can, for example, include at least one drive unit and can, for example, include exactly two drive units.

The term “drive band” within the context of this publication references a drive belt or a drive wheel.

In an embodiment of the present invention, a drive system for slow speed driving can, for example, be provided for the following operation. During the following operation, the accompanying supply platform follows the large good so that this operation can also be referred to as an “accompanying operation”. The drive system for slow speed driving can, for example, include at least one drive unit having a drive binding, a standard transmission, a (for example) electromagnetically operating clutch, a high ratio transmission, an engine, and a brake. In an embodiment, the drive unit of the drive system for slow speed driving can, for example, be made up of these components.

The drive system for slow speed driving (thus, the slow speed drive system) can, for example, include at least one drive unit and can, for example, include exactly two drive units.

The drive system for fast speed driving can, for example, include at least one fast speed drive wheel, and the drive system for slow speed driving can, for example, furthermore include at least one slow speed drive wheel differing therefrom.

The drive system for fast speed driving can, for example, include two fast speed drive wheels, and the drive system for slow speed driving can, for example, furthermore include two slow speed drive wheels differing therefrom.

Since the overall drive system, as already mentioned, can, for example, include one fast speed drive system and one slow speed drive system, the precondition is created that the accompanying supply platform has two operating modes, namely, one fast speed driving mode and one slow speed driving mode. These modes are enabled as follows:

During fast speed driving, the accompanying supply platform can, for example, be moved via the drive system for fast speed driving and the at least one drive unit of the drive system for slow speed driving runs empty as a non-actuated load wheel. In order to protect the components situated behind the clutch of this drive unit (high ratio transmission, engine, brake) from high rotational speed, they can, for example, be separated via the clutch.

During the following operation, the brake of the at least one drive unit of the drive system for fast speed driving can, for example, be released and this drive unit can, for example, furthermore run empty as a non-actuated load wheel. The actuation is now carried out via the drive system for slow speed driving in which the clutch couples the standard transmission with the previously separated components in this operating mode.

In an embodiment of the present invention, the accompanying supply platform can, for example, thus be selectively actuated via the drive system for fast speed driving or the drive system for slow speed driving. In this instance, only the at least one drive unit of the drive system for slow speed driving has a clutch which separates components of the drive unit during the active use of the drive system for fast speed driving. This is because it has been shown that the drive system for fast speed driving is not damaged if it runs passively during slow speed driving without components of this system being separated by a clutch.

Each drive unit can, for example, be steerable.

In an embodiment of the present invention, the accompanying supply platform can, for example, have a fully automatic steering mode and can, for example, also have a manual steering mode. In this instance, the fast speed driving operating mode can, for example, be carried out in the manual steering mode. The following operating mode, in which the accompanying supply platform follows the mounting unit, can, for example, be carried out in the fully automatic steering mode.

In an embodiment of the present invention, the accompanying supply platform can, for example, include a goods elevator. In this embodiment, the accompanying supply platform may be designed as a self-propelled accompanying goods elevator.

A further aspect of the present invention is to create an assembly column for very slowly moving, large goods.

In an embodiment, the present invention provides an assembly column for a large good which moves very slowly which includes a mounting unit which is configured to be attached to the large good, and an accompanying supply platform. The accompanying supply platform includes an overall drive system, and a device configured to automatically follow the mounting unit so as to avoid contact therewith.

The present invention thus also includes an assembly column for very slowly moving, large goods having a mounting unit, and an accompanying supply platform according to one of the exemplary embodiments described above. The assembly column may be a mounting and/or installation column.

In an embodiment of the present invention, the mounting unit can, for example, be attached to the large good. The mounting unit can, for example, thus have a fastening device for attachment to the large good. It is thereby provided without further action that the mounting unit follows the large good in respect to speed and direction.

In an embodiment of the present invention, the device of the accompanying supply platform can, for example, include monitoring devices for an automatic, contactless following of the mounting unit. Devices which interact with these monitoring devices can, for example, be situated at the mounting unit.

The devices can, for example, include targets for sensors. Coarse alignment devices for a driver can, for example, additionally be provided at the mounting unit. These targets for sensors and the coarse alignment device for a driver can, for example, be situated at a common element at the mounting unit, namely, a positioning aid.

The sensor targets may include reflectors and/or drilled holes and/or bright areas.

The coarse alignment device may include a symbol visible to the naked eye, for example, arrows situated at the mounting unit which indicate the correct alignment of the supply platform with the mounting unit. The coarse alignment device may also indicate the correct alignment of parts or areas, for example, of the outer edges of the supply platform with the mounting unit.

The coarse alignment device may include bright areas making it visible to the driver when a laser beam of a sensor is positioned on these areas.

The present invention will now to be described in greater detail on the basis of the exemplary embodiments shown in the drawings.

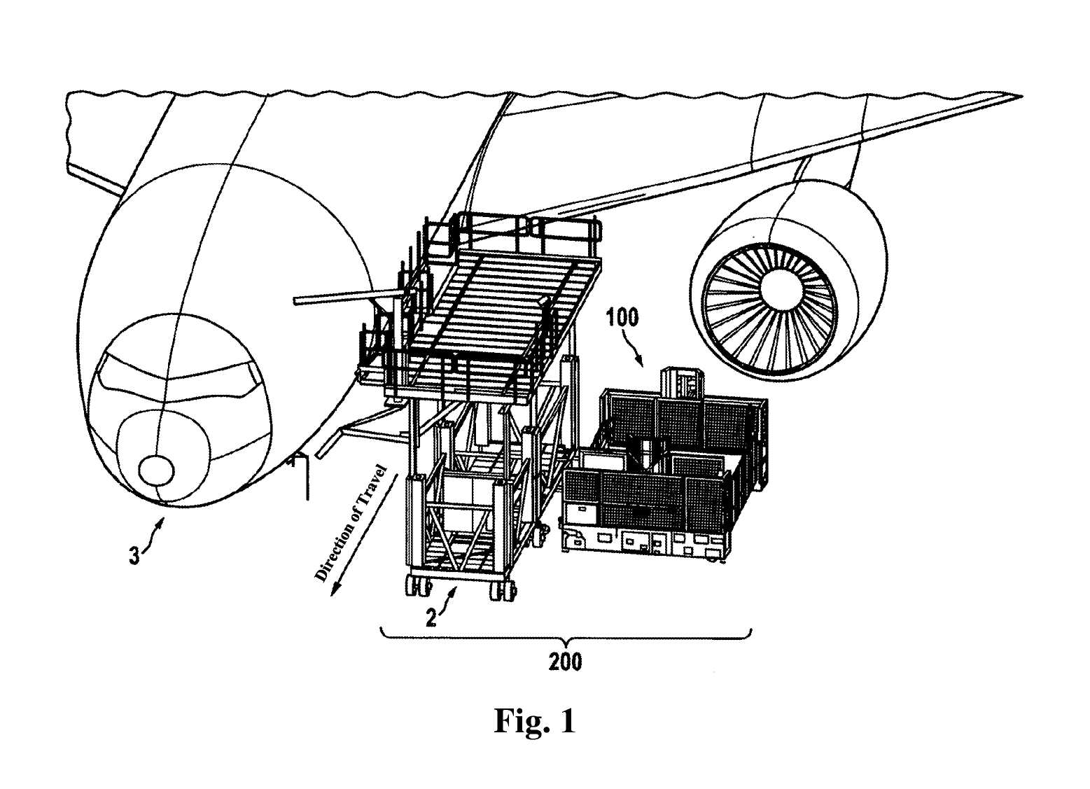

FIG. 1 shows the accompanying supply platform in its entirety with reference character 100 during a following operation. A mounting unit 2 is attached to a large good, namely an aircraft. Large good 3 and mounting unit 2 move at the same, very slow speed, for example, at 1 mm to 100 mm per minute. The accompanying supply platform 100 follows mounting unit 2 in respect to speed and direction without contacting mounting unit 2. In doing so, accompanying supply platform 100 does not put any load on the fastening device between mounting unit 2 and large good 3. Mounting unit 2 has wheels 2a, 2a′.

In order to provide the contactless following, the accompanying supply platform 100 has an overall drive system 1 which itself has two differently constructed, separate drive systems 7, 8. The drive system for fast speed driving 7 thereby includes other drive wheels 15a than the drive system for the following operation 8.

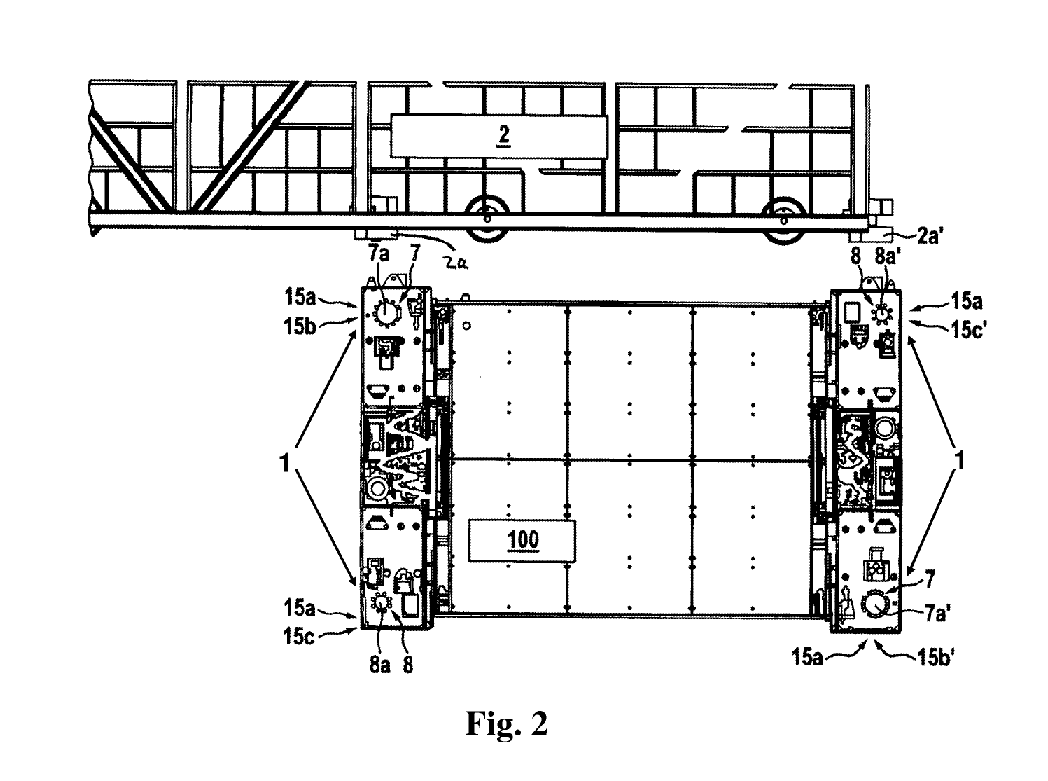

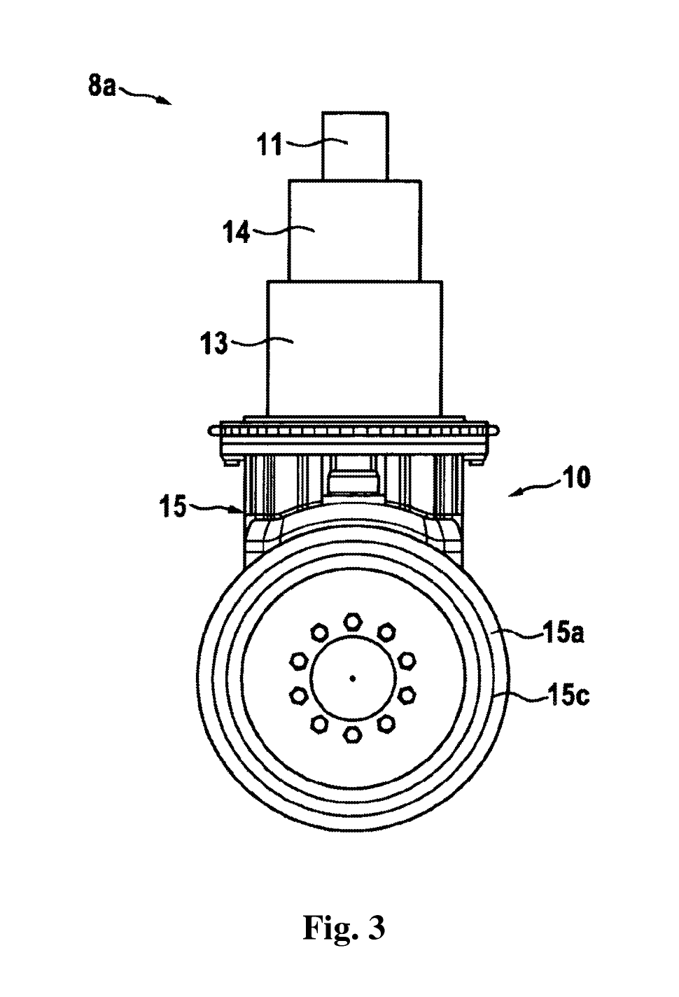

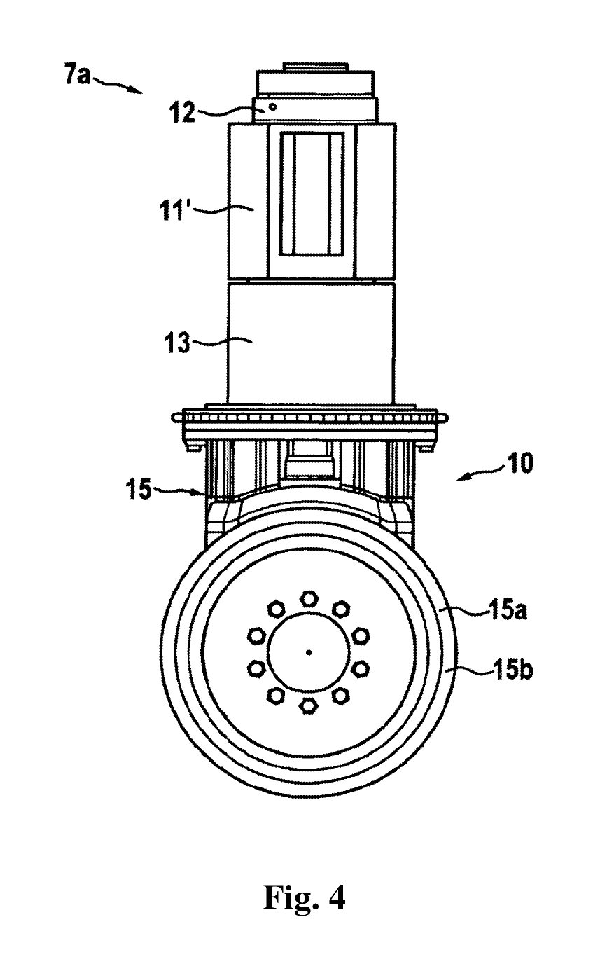

The accompanying supply platform 100 has four wheels in the shown embodiment. Each wheel is actuated so that four drive wheels 15a are provided. As shown in FIG. 2, drive system for fast speed driving 7 and the drive system for following operation 8 respectively include two drive units 7a, 7a′, 8a, 8a′. FIGS. 3 and 4 show that each drive unit 8a, 7a includes exactly one drive wheel 15a. In this instance, the two drive units of a drive system 7, 8 are respectively diagonally situated, thus, at diagonally opposite corners of accompanying supply platform 100.

The drive system for fast speed driving 7 includes two fast speed drive wheels 15b, 15b′, and the drive system for following operation 8 includes two slow speed drive wheels 15c, 15c′ which are different therefrom.

FIG. 3 shows the composition of one of two drive units for the following operation 8a of drive system for the following operation 8. In the shown embodiment, this drive unit 8a is made up of a drive wheel 15a, a standard single cycle engine 15, a standard transmission 10, an electromagnetic clutch 13, a high ratio transmission 14, an engine 11, and a brake 12 (which is not shown in FIG. 3).

The drive unit for fast speed driving 7a shown in FIG. 4 includes a standard drive made up of drive wheel 15a, a standard single cycle engine 15, a standard transmission 10, a standard drive engine 11′, and an electromagnetic brake 12. An electric clutch 13 is also provided. Both drive units of the two drive systems are thus primarily composed of standard components.

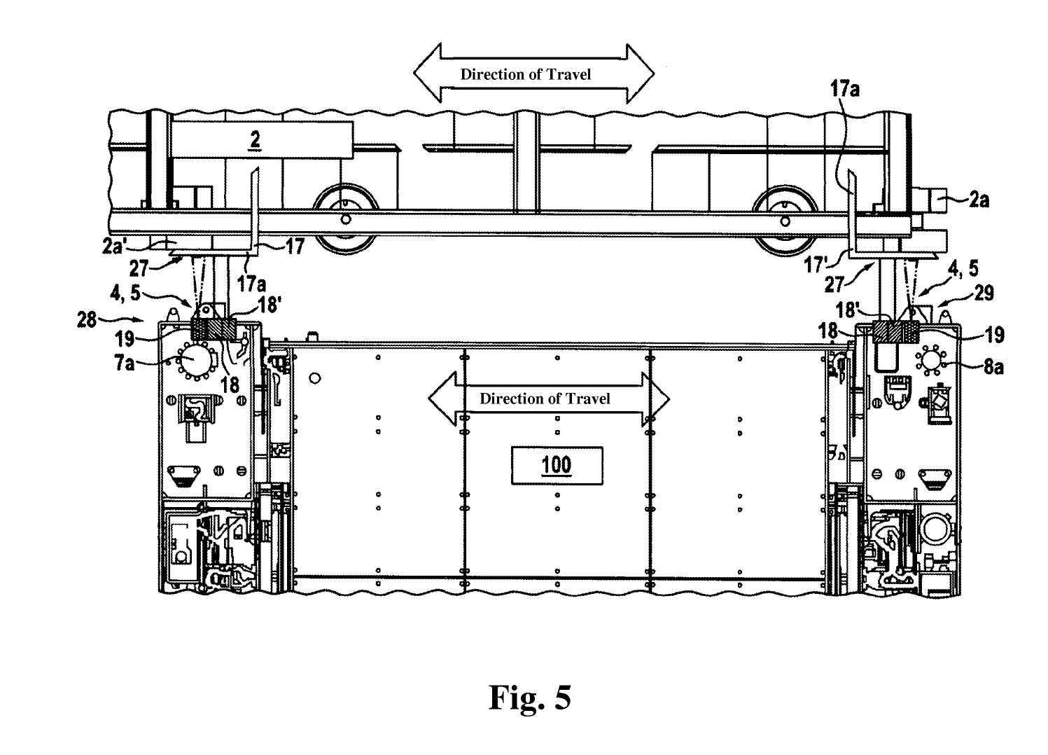

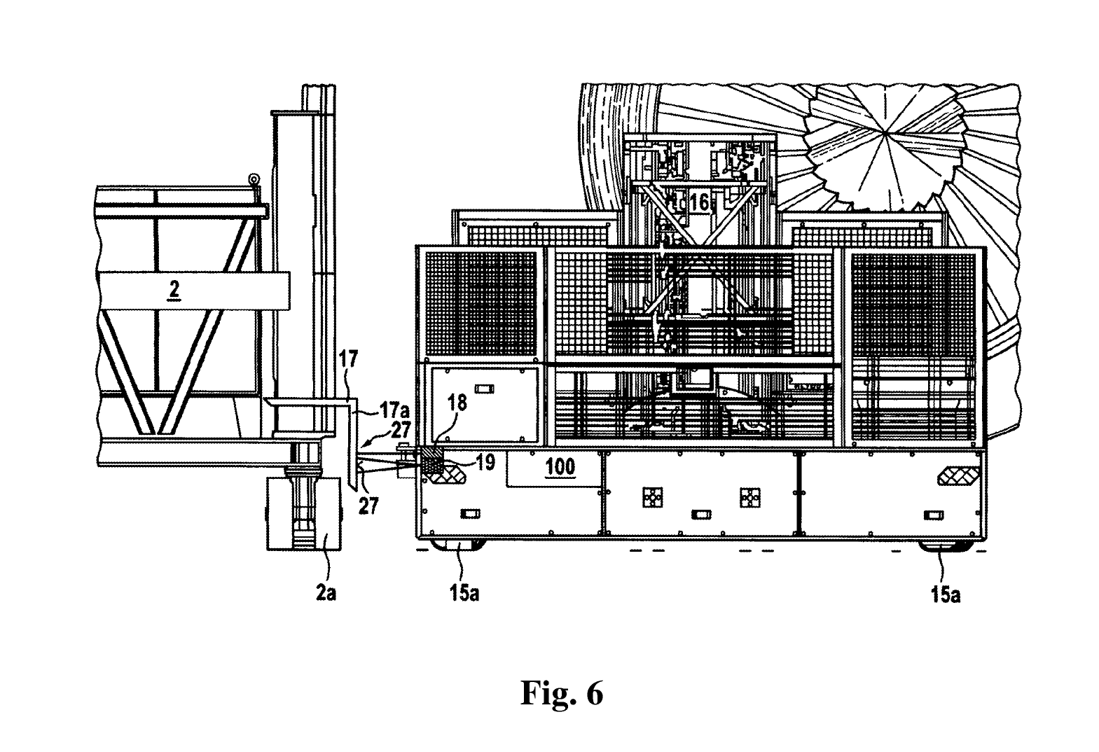

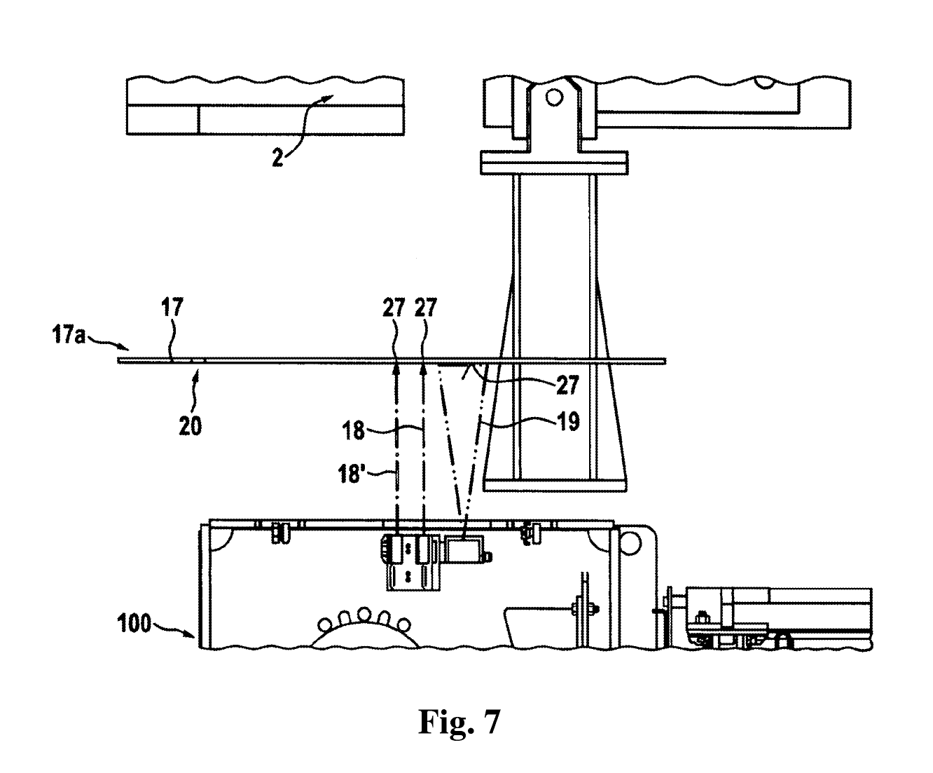

In order to be able to follow mounting unit 2 in an automatic, contactless manner, the accompanying supply platform 100 has a device 4 which include monitoring devices 5. Monitoring devices 5 continuously monitor the position of accompanying supply platform 100 and of mounting unit 2 to each other. Monitoring devices 5 include distance sensors 18, 18′ and position sensors 19. FIG. 5 shows the schematic arrangement of the position sensors 19/distance sensors 18, 18′.

In order to be able to determine the position of two areas of accompanying supply platform 100 and, in doing so, the position of the overall accompanying supply platform 100 relative to mounting unit 2, the distance sensors 18, 18′ and the position sensors 19 are provided in two different areas of accompanying supply platform 100. In the shown embodiment, two distance sensors 18, 18′ are situated in each sensor area 28, 29 of accompanying supply platform 100. Distance sensors 18, 18′ are redundantly connected. One redundant distance sensor 18 is thus provided in each sensor area 28, 29. A collision of accompanying supply platform 100 with mounting unit 2 is thereby reliably prevented. Distance sensors 18 control the steering of accompanying supply platform 100. A position sensor 19 is also provided in each sensor area 28, 29 of accompanying supply platform 100. This position sensor controls the speed of accompanying supply platform 100.

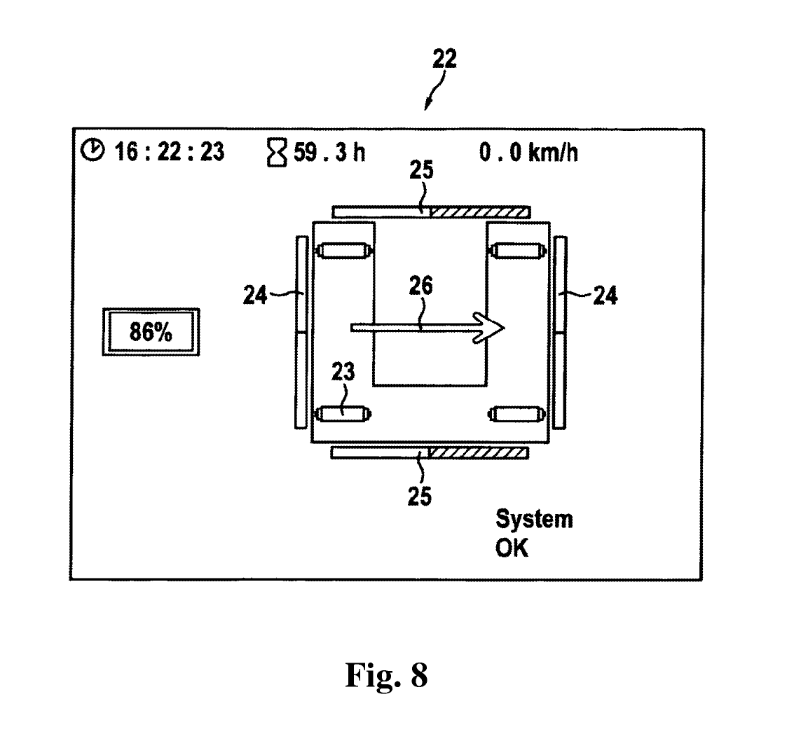

FIG. 8 shows a display, facilitating it for the driver of accompanying supply platform 100 to coarsely align accompanying supply platform 100 with mounting unit 2, that is to align so that the distance sensors 18 and the position sensors 19 may, by way of the main computer, take over the further steering of accompanying supply platform 100. The display 22 shown in FIG. 8 thus facilitates the transition from the manual steering mode to the fully automatic steering mode. For this purpose, two position displays 24 parallel to each other are provided which display the parallelism of accompanying supply platform 100 to mounting unit 2. Provided perpendicularly to position displays 24, two additional position displays 25, also parallel to each other, are provided displaying the centricity of accompanying supply platform 100 to mounting unit 2. In this instance, the hatched area of the latter mentioned position displays 25 symbolizes, in conjunction with arrows 26, a prompt for the driver to move the vehicle respective of the direction of the down dip. If these hatched areas, such as position displays 24 displaying the parallelism, are small, it means that the position of accompanying supply platform 100 is correct in this direction. Display 22 also has a tire position display 23.

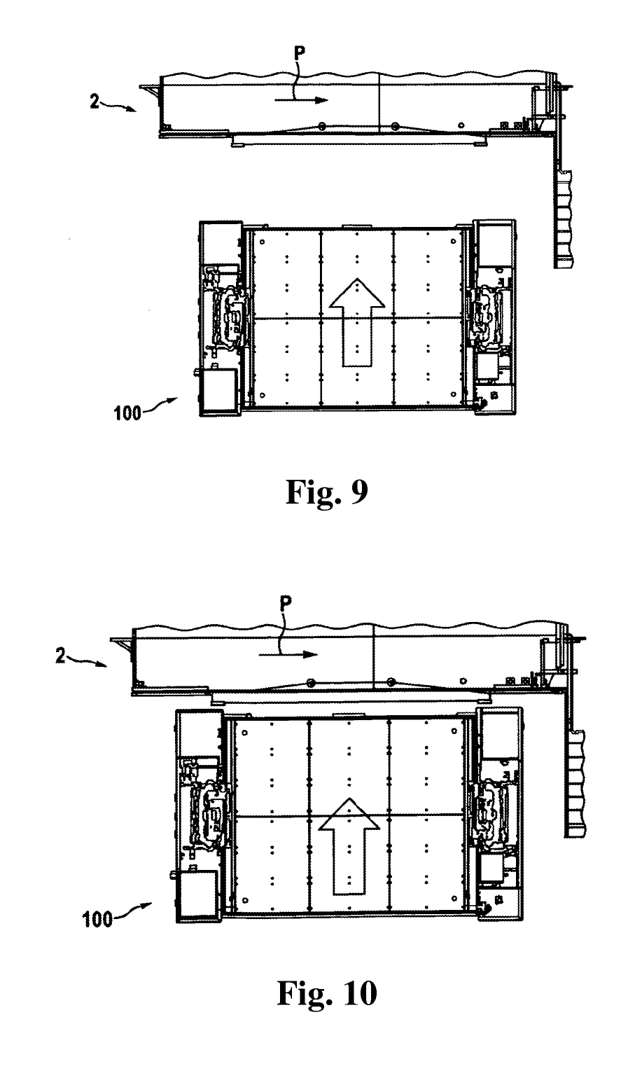

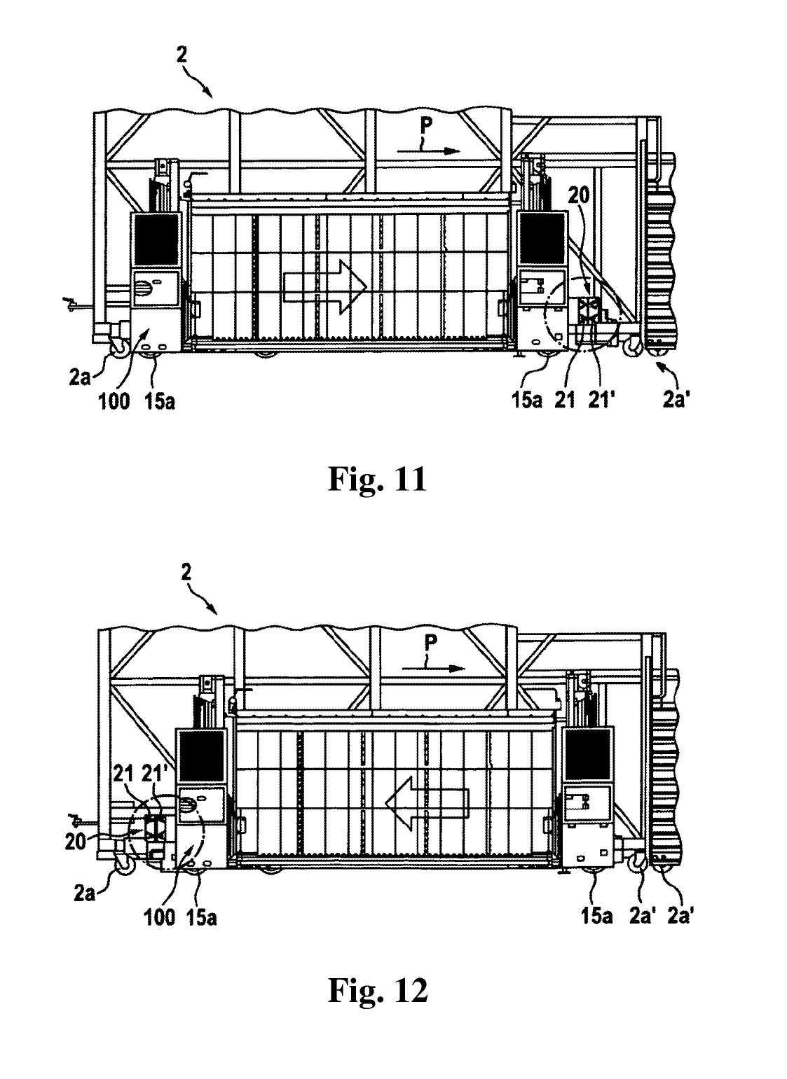

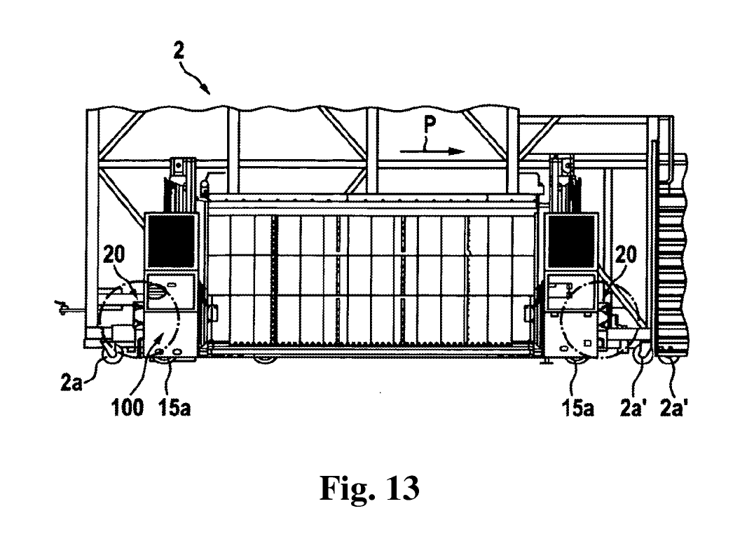

FIGS. 9 through 13 show five steps of coarse alignment of the accompanying supply platform 100 to mounting unit 2. This coarse alignment is carried out in the manual steering mode, that is, by the driver of accompanying supply platform 100. FIGS. 9 and 10 show the approach of accompanying supply platform 100 to mounting unit 2 until the desired distance is reached. The position of accompanying supply platform 100 in the direction of driving, which in FIGS. 9 through 11 is symbolized through arrow P, is subsequently corrected. This is carried out via a coarse alignment device 20 which can, for example, include arrows 21, 21′ which display the correct position of the front and rear edge of the accompanying supply platform to mounting unit 2. In this instance, FIG. 11 shows the position in which accompanying supply platform 100 is situated too far to the left, while FIG. 12 shows the position in which accompanying supply platform 100 is situated too far to the right. FIG. 13 shows a correct alignment. In this situation, a switching from the manual steering mode to the fully automatic steering mode occurs in that accompanying supply platform 100 follows mounting unit 2 in an automatic, contactless manner.

FIG. 1 also shows assembly column 200 which includes mounting unit 2 and accompanying supply platform 100.

As it is shown in more detail in FIG. 5, devices 17, which cooperate with monitoring devices 5 of mounting unit 2, are situated at the mounting unit 2. Devices 17, 17′ include exactly one positioning aid 17a for each sensor area 28, 29 of accompanying supply platform 100. Sensor targets 27, which may be designed as drilled holes, reflectors or bright areas, are situated on the positioning aid.

The present invention is not limited to embodiments described herein; reference should be had to the appended claims.

### LIST OF REFERENCE CHARACTERS

100 Accompanying supply platform

200 Assembly column

1 Overall drive system

2 Mounting unit

2a, 2a′ Wheels

3 Large good

4 Device

5 Monitoring devices

7 Drive system for fast speed driving or standard speed driving

7a, 7a′ Drive unit for fast speed driving or standard speed driving

8 Drive system for the following operation

8a, 8a′ Drive unit for the following operation

10 Standard transmission

11 Engine or drive engine

11′ Standard drive engine

12 Brake

13 Clutch

14 High ratio transmission or reduction gearing transmission

15 Standard single cycle engine

15a Drive wheels

15b, 15b′ Fast speed drive wheels

15c, 15c′ Slow speed drive wheels

16 Goods elevator

17, 17′ Devices

17a Positioning aid

18, 18′ Distance sensor

19 Position sensor

20 Coarse alignment means

21, 21′ Arrows

22 Display

23 Tire position display

24 Position display regarding parallelism

25 Position display regarding centricity

26 Movement instruction (arrow)

27 Sensor targets

28 Sensor area

29 Sensor area

P Arrow

What is claimed is:

1-12. (canceled)

13. An accompanying supply platform for a very slowly moving mounting unit of a large good, the accompanying supply platform comprising:
an overall drive system; and
a device configured to automatically follow the mounting unit so as to avoid contact therewith.

14. The accompanying supply platform as recited in claim 13, wherein the device comprises at least one monitoring device configured to continuously monitor a position of the accompanying supply platform and of the mounting unit to each other.

15. The accompanying supply platform as recited in claim 14, wherein the at least one monitoring device comprises:
at least one distance sensor; and
at least one position sensor.

16. The accompanying supply platform as recited in claim 14, the device further comprises,
a main computer, to which the position of the accompanying supply platform and of the mounting unit to each other as monitored by the at least one monitoring device is transmitted, the main computer being configured to,
calculate a necessary correction regarding a speed and a direction of the accompanying supply platform based on the position of the accompanying supply platform and of the mounting unit to each other as transmitted by the at least one monitoring device, and
to transmit the necessary correction to the overall drive system.

17. The accompanying supply platform as recited in claim 13, wherein the overall drive system comprises a first drive system and a second drive system which are separate and which are differently composed, the first drive system comprising a drive wheel or drive wheels which are each different than a drive wheel or drive wheels of the second drive system.

18. The accompanying supply platform as recited in to claim 17, wherein the first drive system and the second drive system are each based on standard components.

19. The accompanying supply platform as recited in claim 17, wherein, the first drive system is configured to provide for fast speed driving, the first drive system comprising,
a standard drive comprising a drive band,
a standard transmission,
an engine, and
a brake, and
the second drive system is configured to provide for slow speed driving for the following operation, the second drive system comprising,
a drive band,
a standard transmission,
a clutch,
a high ratio transmission,
an engine, and
a brake.

20. The accompanying supply platform as recited in claim 13, wherein the accompanying supply platform is provided with a fully automatic steering mode and with a manual steering mode.

21. The accompanying supply platform as recited in claim 13, wherein the accompanying supply platform further comprises a goods elevator.

22. An assembly column for a large good which moves very slowly, the assembly column comprising:
a mounting unit which is configured to be attached to the large good; and
an accompanying supply platform comprising,
an overall drive system, and
a device configured to automatically follow the mounting unit so as to avoid contact therewith.

23. The assembly column as recited in claim 22, wherein,
the device configured to automatically follow the mounting unit so as to avoid contact therewith comprises at least one monitoring device, and
the assembly column further comprising:
devices arranged at the mounting unit with which the monitoring devices are configured to cooperate.

24. The assembly column as recited in claim 23, wherein,
the devices comprise at least one sensor target for a sensor, and
the mounting unit comprises a positioning aid,
the assembly column further comprising a coarse alignment device for a driver, wherein the at least one sensor target and the coarse alignment device are each arranged at the positioning aid of the mounting unit.
